(19) United States
(12) Patent Application Publication
(10) Pub. No.: US 2013/0023393 A1
(43) Pub. Date: Jan. 24, 2013

(54) WEAR-RESISTANT ROLLER

(71) Applicant: David Dam Olsson, Brabrand (DK)

(72) Inventor: David Dam Olsson, Brabrand (DK)

(73) Assignee: FLSMIDTH A/S, Valby (DK)

(21) Appl. No.: 13/639,127

(22) PCT Filed: Mar. 14, 2011
(86) PCT No.: PCT/IB11/51060

§ 371 Date: Oct. 3, 2012

(30) Foreign Application Priority Data
Apr. 16, 2010 (DK) PA 2010 00315

(51) Int. Cl. A01B 29/00; B21D 53/00

(52) U.S. Cl. 492/28; 29/895

(57) ABSTRACT

A description is given of a method for producing a wear-resistant roller for crushing of particulate material, such as crude ore for use in the mineral industry, by which method the surface region of the roller (1) is provided with a plurality of recesses (2) into each of which a wear-resistant component (3) is embedded. The method is characterized in that at least some of the material around each recess (2) is plastically deformed after the wear-resistant component (3) is placed in the recess and in that the deformed material changes the shape of the recess (2) and secures the wear-resistant component (3) to the roller (1).

The present invention relates to a method of producing a wear-resistant roller for crushing of particulate material, such as crude ore for use in the mineral industry, by which method the surface region of the roller is provided with a plurality of recesses into each of which a wear-resistant component is embedded. The invention also relates to a wear-resistant roller produced according to the method.

The wear-resistant roller may for example be used in a high-pressure roller press, in a vertical roller mill or in similar equipment for crushing of particulate material.

A wear-resistant roller of the aforementioned kind is known from EP 0516952 B1. The European patent describes a roller press where the rollers comprise a plurality of cylindrical pins embedded in the crushing surface. The cylindrical pins, which are made of wear-resistant material, are inserted in drilled holes in the crushing surface of the roller and secured by means of a shrink fit connection or a similar arrangement. The greater part of each pin is embedded in the roller whereas the rest protrudes from the surface of the roller. The pins have a large length to diameter ratio and it is therefore necessary to have most of the pins embedded in the roller due to the quite substantial loads the pins are subjected to. The wear-resistant material of which the pins are made is very expensive and by embedding the greater part of each pin in the roller, whereas only a smaller portion of the pin protrudes from the roller surface, most of the expensive material is not subjected to wear, which is a poor utilization of the wear-resistant material. It also makes the manufacture of such a wear-resistant roller costly. Therefore it would be advantageous to embed less of each pin in the surface region of the roller. Given that the pins and holes must fit each other exactly in order to withstand the high loads occurring during operation they must be manufactured with a high degree of precision and since the entire circumference of the roller is covered with pins it is a very time-consuming process to manufacture such a roller. It would be preferable to have less requirements to the precision of the holes and the pins and it would furthermore be advantageous to use wear-resistant material which is not cylindrical, instead having various shapes, in order to optimize the strength of the wear-resistant material to increase the service life of the roller.

It is the object of the present invention to provide a wear-resistant roller by means of which the described disadvantages are eliminated or reduced.

This is obtained by a wear-resistant roller of the kind mentioned in the introduction, and being characterized in that at least some of the material around each recess is plastically deformed after the wear-resistant component is placed in the recess and in that the deformed material changes the shape of the recess and secures the wear-resistant component to the roller.

In this way it will possible to use wear-resistant components having various shapes as the plastic deformation for securing the components do not dictate a specific shape of components. An optimal shape of the components increases their endurance resulting in a prolonged life of the wear-resistant roller. The possibility of using various designs of the components makes it possible to design them in such a way that only a small section of the components is required to be embedded in the roller. Furthermore the requirements as to tolerances between the wear-resistant components and the recesses are low because the securing of the components is effected by deformation of material. Due to the above-mentioned the costs of manufacture and maintenance of such a wear-resistant roller are relatively low.

The components of wear-resistant material may have all kind of possible shapes as long as they have the ability to be secured in the surface region of the roller by means of a controlled plastic deformation of the surrounding roller material and as long as the shape offers the component sufficient strength to withstand the loads imposed during the operation of the rollers. It is preferred that each wear-resistant component comprises at least one section, in the axial direction of the component, having a smaller cross-sectional area than a section of the component which is closer to the bottom of the recess and that some of the material around the recesses is deformed until a permanent connection is established with the section with the smaller cross-sectional area. It is understood that the axial direction of the component is the direction in which the component protrudes from the roller surface. In this way it is ensured that the deformed material holds and fastens the components to the roller. The wear-resistant component may be rotational-symmetrical with at least one inclined section in the axial direction of the component, where the widest part of the inclined section is located closest to the bottom of the recess. Preferably the inclined section has a substantially conical shape. The wear-resistant components may not be rotational-symmetrical but for example have a rectangular, quadratic, oval or pentagonal shape.

It is preferred that only a part of the wear-resistant component, which is composed of a material which is harder than the material of the roller, is embedded in the roller whereas the rest of the component is protruding from the surface of the roller.

The recesses may have all kind of possible shapes as long as they allow the wear-resistant components to be secured in the recesses by means of plastic deformation of the roller material. The recesses may be longitudinal grooves in the axial direction of the roller or holes in the surface of the roller. If the recesses are cylindrically holes the diameter of the hole may exceed the depth of the hole. Complementary components for such holes will have a small length to diameter ratio and a large circumference compared to the protruding part of the component. Such components do not have to be embedded very deep into the roller as they will have a large surface area embedded in the roller to take up the imposed load.

The plastic deformation of the material around the components is achieved by pressing a tool, which surrounds at least a part of one or more components, against the roller material in the vicinity of the components. The pressure on the material continues until the desired plastic deformation is reached which is when the shape of the recesses is changed in a way that secures the components to the roller. Usually the pressure to this tool is generated by means of hydraulics.

The invention will now be explained in greater detail with reference to the drawing, being diagrammatical, and where

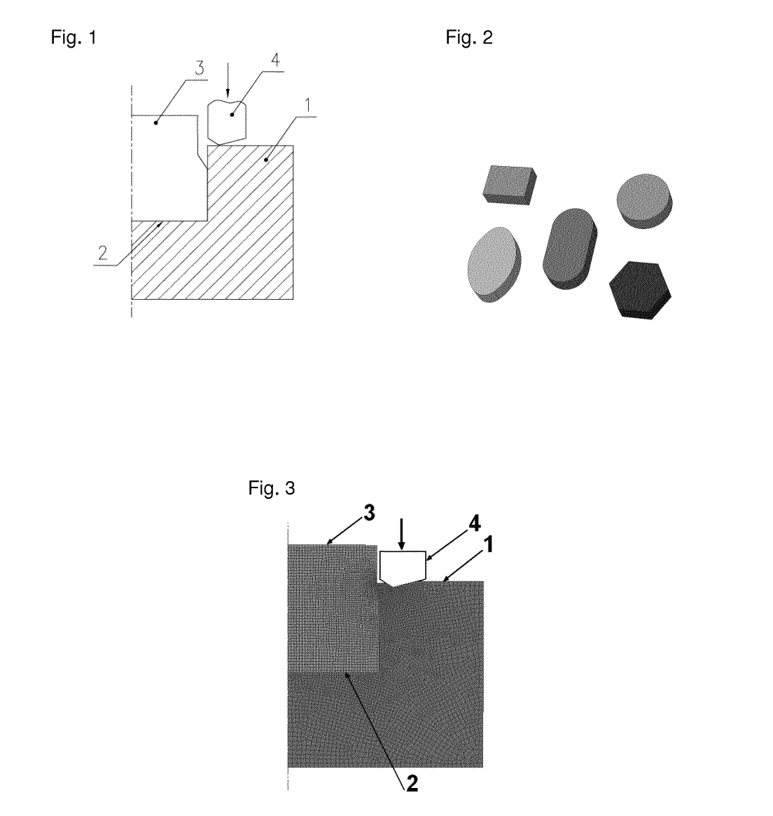

FIG. 1 shows a cross-section of a wear-resistant roller according to the invention,

FIG. 2 shows various shapes of the wear-resistant components, and

FIG. 3 shows a Finite Element view of a wear-resistant component secured by plastic deformation of the roller material.

FIG. 1 shows a cross-section of a wear-resistant roller 1 where a wear-resistant component 3 is placed in a complementary recess 2 in the roller 1 before some of the roller material surrounding the component 3 is subjected to plastic deformation. The recess 2 is a blind hole having a straight cylindrical wall and the component 3 has an upper cylindrical section, a middle conical section and a lower cylindrical section. Other shapes of components 3 are possible as long as each component 3 comprises at least one section, in the axial direction of the component 3, having a cross-section with a smaller area than a section of the component 3 which is closer to the bottom of the recess 2. In this way the deformed material is capable of securing the wear-resistant component 3 to the roller 1. A tool 4 surrounding at least a part of the component 3 is forced against the roller material in the vicinity of the component 3 until the desired plastic deformation of the roller material is achieved. The deformation of the roller material continues until the deformed roller material makes a permanent connection with the middle conical section as the component 3 will then be fixed to the roller 1. In this case with a rotational-symmetrical component 3 the tool 4 is ring-shaped. If other shapes of components 3 are used the tool 4 is manufactured according to the specific shape.

In another embodiment (not shown) an intermediate material is applied between the wear-resistant components 3 and the recesses 2 to retain the components 3 to the roller 1. In this case it is not the roller material but this intermediate material which will be subjected to the plastic deformation. In such a case not only the components 3 but also the recesses 2 must have a design with different cross-sectional areas in order to be applicable. By using an intermediate material for the plastic deformation it is achieved that a wide range of materials are available for the purpose of retaining the components 3.

FIG. 2 shows various shapes of the wear-resistant components 3. Only the main geometry of the components 3 is shown, not inclined sides or other features necessary to secure the components 3 to the roller 1. Rectangular, cylindrical, oval and pentagonal shapes for the components 3 are shown, but also other shapes are applicable. The optimal geometry of the components 3 will inter alia be dependent on the material to be processed and the force exerted on the roller 1. The recesses 2 are manufactured to correspond to the shape of the components 3.

FIG. 3 shows a Finite Element view of a section of the wear-resistant roller where a wear-resistant component 3 is fixed to the roller 1 by means of plastic deformation of the roller material. The component 3 has an upper cylindrically section, a middle conical section and a lower cylindrical section. The tool 4 is pressed into the roller material and it is seen in the figure that only a small area around the component 3 is subjected to the deformation and that the deformed material establishes a permanent connection with the middle conical section whereby the component 3 is secured to the roller 1.

1. A method of producing a wear-resistant roller for crushing of particulate material, such as crude ore for use in the mineral industry, by which method the surface region of the roller is provided with a plurality of recesses into each of which a wear-resistant component is embedded, wherein at least some of the material around each recess is plastically deformed after the wear-resistant component is placed in the recess and in that the deformed material changes the shape of the recess and secures the wear-resistant component to the roller.

2. A method of producing a wear-resistant roller according to claim 1, wherein each wear-resistant component comprises at least one section, in the axial direction of the component, having a smaller cross-sectional area than a section of the component which is closer to the bottom of the recess and in that some of the material around the recess is deformed until a permanent connection is established with the section with the smaller cross-sectional area.

3. A wear-resistant roller for crushing of particulate material, such as crude ore for use in the mineral industry, comprising a roller provided with a plurality of wear-resistant components embedded in complementary recesses provided in the surface region of the roller, wherein some of the material around the recesses is subjected to plastic deformation which changes the shape of the recesses and in that the deformed material secures the wear-resistant components to the roller.

4-8. (canceled)

9. A wear-resistant roller according to claim 3, wherein the recesses are cylindrical holes.

10. A wear-resistant roller according to claim 3, wherein the recesses are longitudinal grooves in the axial direction of the roller.

11. A wear-resistant roller according to claim 3, wherein only a part of the wear-resistant component is embedded in the roller whereas the rest of the component is protruding from the surface of the roller.

12. A wear-resistant roller according to claim 3, wherein each wear-resistant component comprises at least one inclined section in the axial direction of the component, where the widest part of the inclined section is located closest to the bottom of the recess.

13. A wear-resistant roller according to claim 12, wherein the inclined section has a substantially conical shape.

14. A wear-resistant roller according to claim 12, wherein the recesses are cylindrical holes.

15. A wear-resistant roller according to claim 12, wherein the recesses are longitudinal grooves in the axial direction of the roller.

16. A wear-resistant roller according to claim 12, wherein only a part of the wear-resistant component is embedded in the roller whereas the rest of the component is protruding from the surface of the roller.

17. A wear-resistant roller according to claim 13, wherein the recesses are cylindrical holes.

18. A wear-resistant roller according to claim 13, wherein the recesses are longitudinal grooves in the axial direction of the roller.

19. A wear-resistant roller according to claim 13, wherein only a part of the wear-resistant component is embedded in the roller whereas the rest of the component is protruding from the surface of the roller.

20. A wear-resistant roller according to claim 17, wherein only a part of the wear-resistant component is embedded in the roller whereas the rest of the component is protruding from the surface of the roller.

21. A wear-resistant roller according to claim 18, wherein only a part of the wear-resistant component is embedded in the roller whereas the rest of the component is protruding from the surface of the roller.
